(19) United States
(12) Patent Application Publication
(10) Pub. No.: US 2026/0280661 A1
(43) Pub. Date: Sep. 17, 2026

(54) CELL-SPECIFIC BEAMBOOK DESIGN

(71) Applicant: Samsung Electronics Co., Ltd., Suwon-si (KR)

(72) Inventors: Mustafa Furkan Ozkoc, The Colony, TX (US); Young Han Nam, Plano, TX (US)

(21) Appl. No.: 19/548,791

(22) Filed: Feb. 24, 2026

Related U.S. Application Data
(60) Provisional application No. 63/770,902, filed on Mar. 12, 2025.

(51) Int. Cl. H04B 7/06

(52) U.S. Cl. CPC H04B 7/0639

(57) ABSTRACT

Methods and apparatuses for a cell specific beambook design in wireless communication systems. The method of a BS comprises: receiving, from a UE, cell-specific information; identifying, based on the cell-specific information, at least one cell-specific beambook, wherein the cell-specific information includes beam usage statistics; determining, based on the cell-specific information and a baseline beambook, whether to merge one or more beams in accordance with a first threshold; generating a new cell-specific beambook based on a determination that the one or more beams is merged; and updating the baseline beambook based on the new cell-specific beambook.

### CROSS-REFERENCE TO RELATED APPLICATIONS AND CLAIM OF PRIORITY

The present application claims priority to U.S. Provisional Patent Application No. 63/770,902, filed on Mar. 12, 2025. The contents of the above-identified patent documents are incorporated herein by reference.

### TECHNICAL FIELD

The present disclosure relates generally to wireless communication systems and, more specifically, the present disclosure relates to a cell specific beambook design in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a cell specific beambook design in wireless communication systems.

In one embodiment, a base station (BS) in a wireless communication system is provided. The BS comprises a transceiver configured to receive, from a user equipment (UE), cell-specific information. The BS further comprises a processor operably coupled to the transceiver, the processor configured to: identify, based on the cell-specific information, at least one cell-specific beambook, wherein the cell-specific information includes beam usage statistics, determine, based on the cell-specific information and a baseline beambook, whether to merge one or more beams in accordance with a first threshold, generate a new cell-specific beambook based on a determination that the one or more beams is merged, and update the baseline beambook based on the new cell-specific beambook.

In another embodiment, a method of a BS in a wireless communication system is provided. The method comprises: receiving, from a UE, cell-specific information; identifying, based on the cell-specific information, at least one cell-specific beambook, wherein the cell-specific information includes beam usage statistics; determining, based on the cell-specific information and a baseline beambook, whether to merge one or more beams in accordance with a first threshold; generating a new cell-specific beambook based on a determination that the one or more beams is merged; and updating the baseline beambook based on the new cell-specific beambook.

In yet another embodiment, a UE in a wireless communication system is provided. The UE comprises a processor configured to generate cell-specific information including beam usage statistics. The UE further comprises a transceiver operably coupled to the processor, the transceiver configured to transmit, to a base station (BS), the cell-specific information, wherein: based on the cell-specific information, at least one cell-specific beambook is identified, based on the cell-specific information and a baseline beambook, whether to merge one or more beams is determined in accordance with a first threshold, a new cell-specific beambook is generated based on a determination that the one or more beams is merged, and the baseline beambook is updated based on the new cell-specific beambook.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates a flowchart of method for a cell specific beambook design procedure according to various embodiments of the present disclosure;

FIG. 8 illustrates another flowchart of method for a cell specific beambook design procedure according to various embodiments of the present disclosure;

FIG. 9 illustrates yet another a flowchart of method for a cell specific beambook design procedure according to various embodiments of the present disclosure;

FIG. 10 illustrates a flowchart of method for beam merging according to various embodiments of the present disclosure;

FIG. 11 illustrates an example of beam merging according to various embodiments of the present disclosure;

FIG. 12 illustrates another flowchart of method for beam merging according to various embodiments of the present disclosure;

FIG. 13 illustrates another example of beam merging according to various embodiments of the present disclosure;

FIG. 14 illustrates yet another example of beam merging according to various embodiments of the present disclosure;

FIG. 15 illustrates an example of beamforming weight optimization according to various embodiments of the present disclosure;

FIG. 16 illustrates an example of beamforming weight optimization according to various embodiments of the present disclosure;

FIG. 17 illustrates another flowchart of method for beam splitting according to various embodiments of the present disclosure;

FIG. 18 illustrates yet another example of beam splitting according to various embodiments of the present disclosure;

FIG. 19 illustrates another flowchart of method for identifying beamforming weight according to various embodiments of the present disclosure;

FIG. 20 illustrates another example of beamforming weight optimization according to various embodiments of the present disclosure;

FIG. 21 illustrates another example of beamforming weight optimization according to various embodiments of the present disclosure;

FIG. 22 illustrates a flowchart of method for splitting a set of beams according to various embodiments of the present disclosure;

FIG. 23 illustrates a flowchart of method for splitting a set of beams and identifying a new beam according to various embodiments of the present disclosure;

FIG. 24 illustrates another flowchart of method for merging and splitting a set of beams and identifying a new beam(s) according to various embodiments of the present disclosure;

FIG. 25 illustrates a flowchart of method for cell specific design according to various embodiments of the present disclosure;

FIG. 26 illustrates yet another example of beamforming weight optimization according to various embodiments of the present disclosure;

FIG. 27 illustrates another flowchart of method for cell specific design according to various embodiments of the present disclosure;

FIG. 28 illustrates yet another flowchart of method for cell specific design according to various embodiments of the present disclosure;

FIG. 29 illustrates yet another flowchart of method for cell specific design according to various embodiments of the present disclosure;

FIG. 30 illustrates a flowchart of method for a merging operation according to various embodiments of the present disclosure; and

FIG. 31 illustrates a flowchart of method for a cell specific beambook design according to various embodiments of the present disclosure.

### DETAILED DESCRIPTION

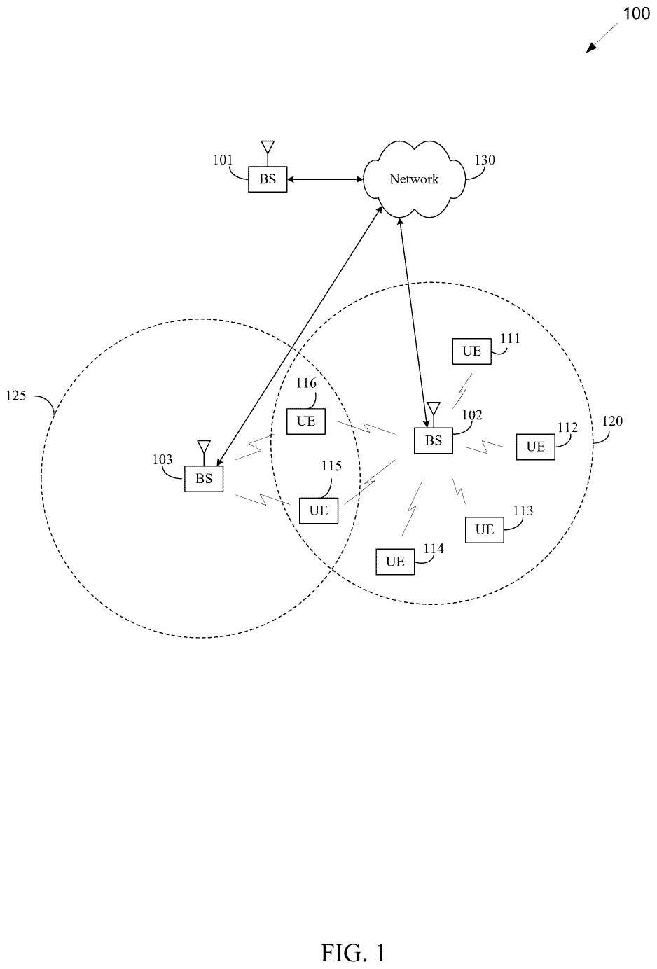

FIG. 1 through FIG. 31 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a cell specific beambook design, at a gNB 101-103, in wireless communication systems. In certain embodiments, and one or more of the gNBs 101-103 includes circuitry, programing, or a combination thereof, to support to a cell specific beambook design in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

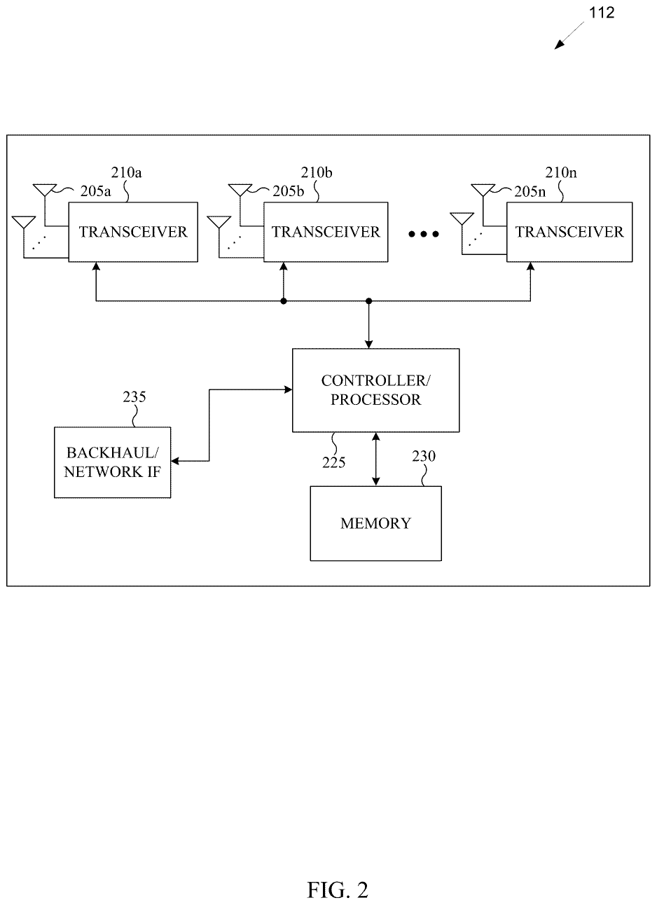

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a cell specific beambook design in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

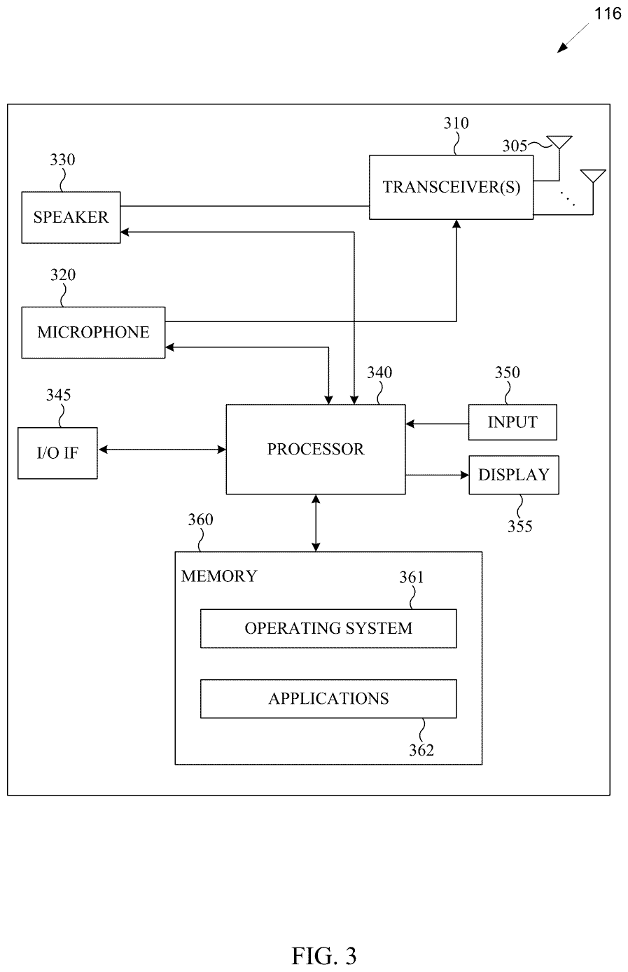

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a cell specific beambook design, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes, for example, a touchscreen, keypad, etc. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

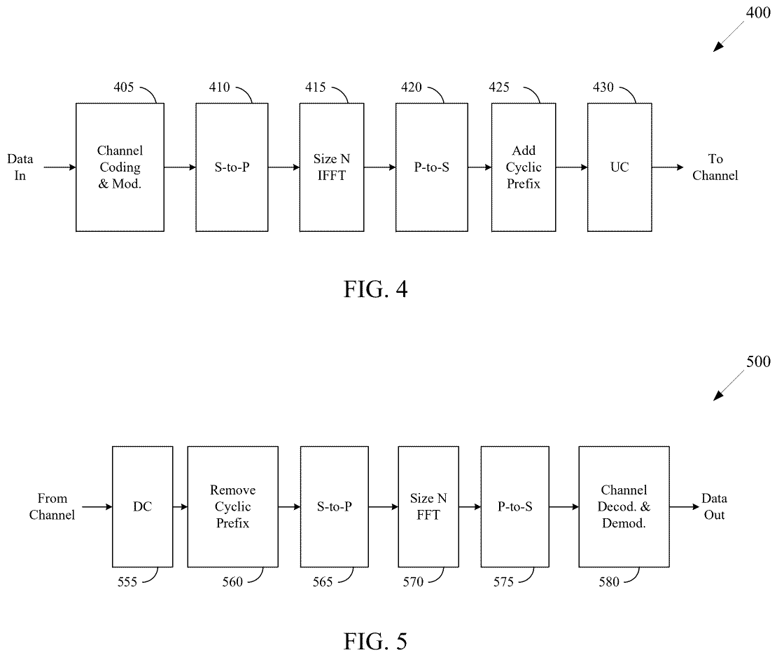

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency and removes cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architecture can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

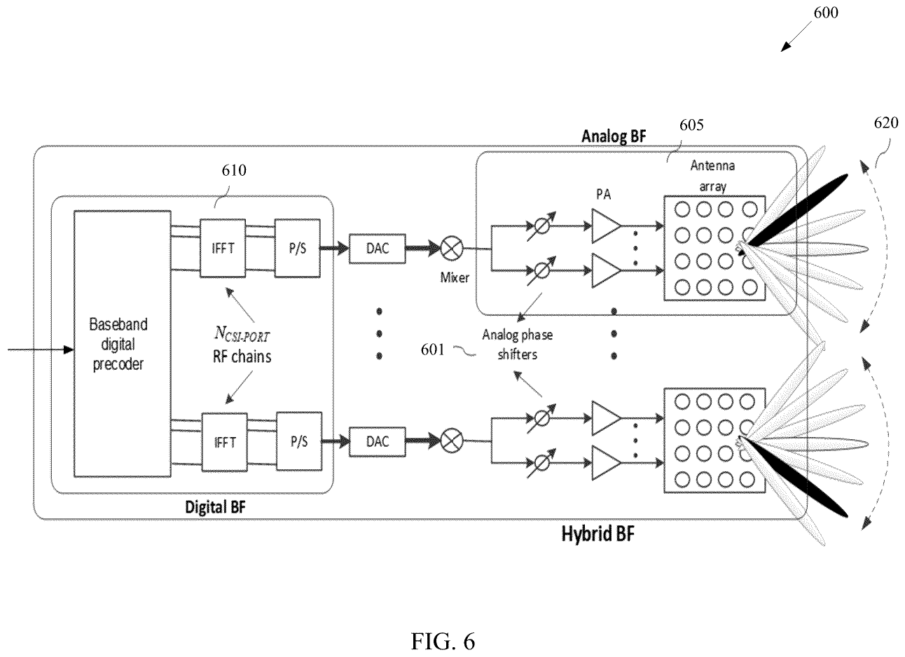

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the 02 absorption loss around 60 GHz frequency (~10 dB additional loss at 100 m distance), larger number of and sharper analog beams (hence larger number of radiators in the array) may compensate for the additional path loss.

In mmWave band beamforming via a codebook is very important and challenging for the 5G mmWave base stations. Unlike the low-frequency bands, beamforming may be performed to support the high data transmission at the mmWave band due to the large mmWave band path loss. Many beams may cover a wide angular region, for example, horizontally from −60 degrees to +60 degrees for a codebook design. A codebook may be designed in cell-common way i.e., the beambook may be common across multiple cells. The present disclosure provides methods and algorithms for designing (or updating) a beam codebook for a cell after the deployment.

The mmWave beambooks are designed with an intent to cover a desired angular coverage range without any cell-specific information. The design can be considered as a cell common beambook design. Given a desired angular coverage range, and in some cases a limit on maximum number of beams or a target number of beams in a codebook, the beams may be designed to cover the angular space as much as possible and achieve as high gain as possible.

Although cell information can be used for determining the angular coverage range, the specifics per cell are not considered. In some designs, the common cell information could include a type of a cell such as urban deployment, rural deployment etc. The cell common beambook design could have shortcomings when used in actual deployment cells. Beams in a codebook may be used by varying frequencies depending on environment. Some beams may serve towards dense user regions and may be used frequently. Some beams may serve sparse user regions and may not be used frequently. For example, beams pointing towards a plaza area in a city center may be used more frequently whereas beams pointing toward a dense foliage may not be used frequently.

In one embodiment, the cell specific beambook could be designed based on a baseline beambook and a collection of cell specific information when the baseline beambook is in use. First, the BS use the baseline beambook and collect cell specific information. Second, the BS or a module or an algorithm, design cell specific beambook based on the collected cell specific information. Third, the serving beambook is updated with the newly designed cell specific beambook.

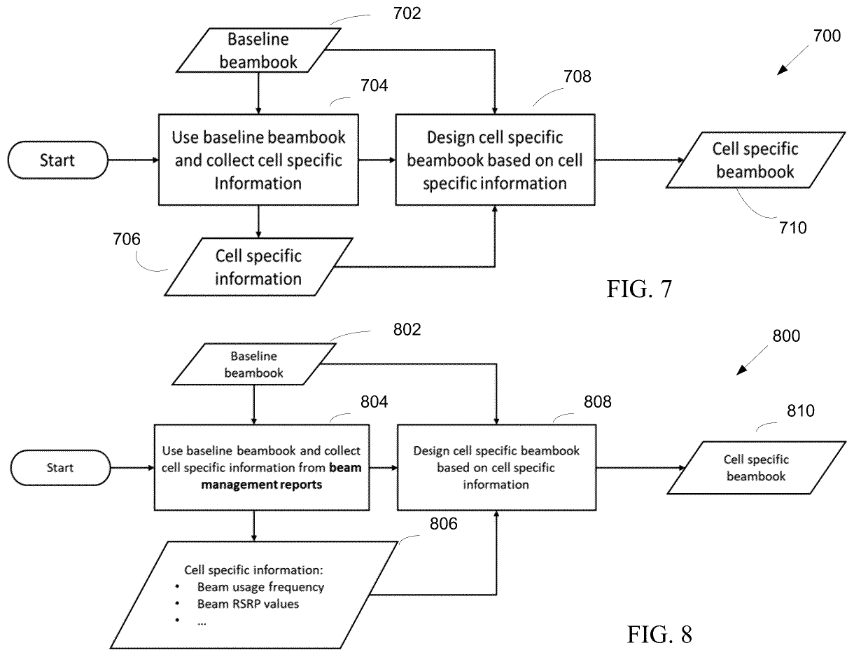

FIG. 7 illustrates a flowchart of method 700 for a cell specific beambook design procedure according to various embodiments of the present disclosure. The method 700 may be performed by a BS (e.g., 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, in step 702, a baseline beambook is identified. In step 704, the method 700 uses baseline beambook and collects cell specific information. In step 706, the cell specific information is identified. In step 708, the method 700 designs cell specific beambook based on cell specific information. In step 710, the cell specific beambook is identified.

In one embodiment, the cell specific beambook could be designed based on a baseline beambook and a collection of the beam management reports from users in the cell, containing a best beam index, and/or the RSRP value of the best beam when the baseline beambook is in use.

FIG. 8 illustrates another flowchart of method 800 for a cell specific beambook design procedure according to various embodiments of the present disclosure. The method 800 may be performed by a BS (e.g., 101-103 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, in step 802, a baseline beambook is identified. In step 804, the method 700 uses baseline beambook and collects cell specific information from beam management reports. In step 806, the cell specific information is identified, including beam usage frequency, beam RSRP values and so on. In step 808, the method 800 designs cell specific beambook based on cell specific information. In step 810, the cell specific beambook is identified.

In one embodiment, the cell specific beambook could be designed based on a baseline beambook and a collection of channel state information (CSI) of users in the cell. In one example, the CSI could be measured via pilot signals. The pilot signals could be transmitted in the downlink or uplink directions. In one example, a UE could report the CSI information to a BS using a feedback loop and BS could collect reported information to a cell specific information data container. In another example, the CSI is measured via a BS and collected to a cell specific information data container.

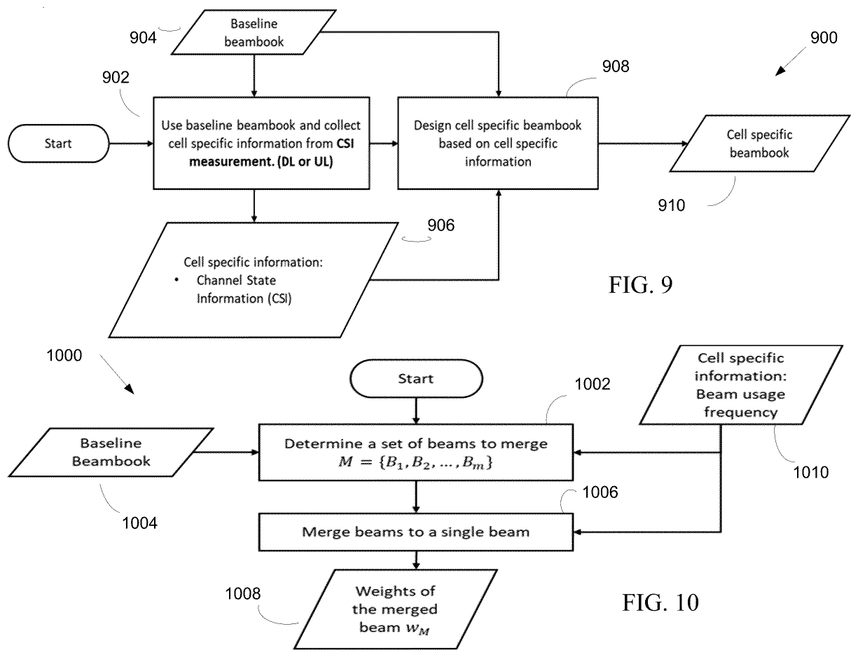

FIG. 9 illustrates yet another a flowchart of method 900 for a cell specific beambook design procedure according to various embodiments of the present disclosure. The method 900 may be performed by a BS (e.g., 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, in step 902, a baseline beambook is used and cell specific information is collected from CSI measurement (e.g., DL or UL). In step 904 a baseline beambook is identified. In step 906, the method 700 uses cell specific information, including channel state information (CSI). In step 908, the method 900 designs cell specific beambook based on cell specific information. In step 910, the cell specific beambook is identified.

In one embodiment, the design target of cell specific beambook could be reducing the number of beams in the codebook via merging a set of beams that are in close proximity to each other into common beam covering the union of the area. In one example, if the beambook is used for an SSB transmission, the reduced number of beams could be transmitted in fewer SSB signals and save the SSB transmission overhead and reduce the total energy consumption of SSB transmission. If the beambook is used for measurements via CSI-RS, the reduced number of beams could save CSI-RS overhead and reduce the measurement burden on a UE.

FIG. 10 illustrates a flowchart of method 1000 for beam merging according to various embodiments of the present disclosure. The method 1000 may be performed by a BS (e.g., 101-103 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in step 1002, the method 1000 determines a set of beams to merge. In step 1004, an output of the baseline beambook is transmitted to step 1002. In step 1006, the method 1000 merges beams to a single beam. In step 1008, the weights of the merged beam is determined. In step 1010, cell specific information (e.g., beam usage frequency) is provided to steps 1002 and 1006.

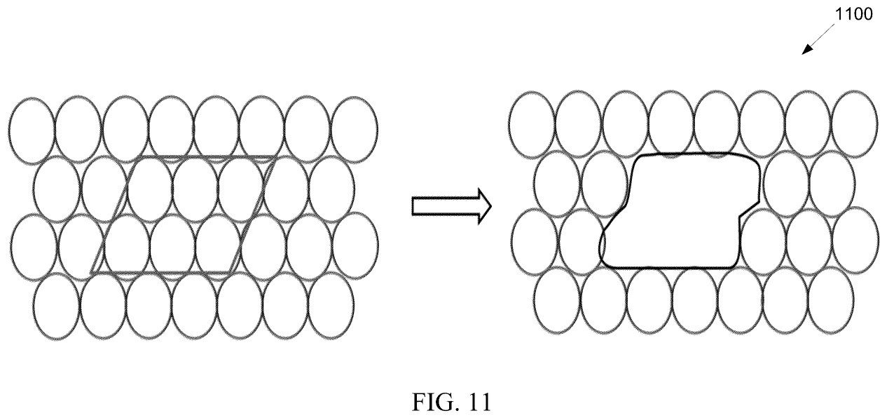

FIG. 11 illustrates an example of beam merging 1100 according to various embodiments of the present disclosure. An embodiment of the beam merging 1100 shown in FIG. 11 is for illustration only.

In one embodiment, a set of beams to be merged could be determined based on their usage counts. In one example, the algorithm could determine a beam with zero usage in the collected cell specific information i.e., no user reported this particular beam as the best beam. The determined beam could be included as the first beam in the set of the beams to be merged. Next, the algorithm could determine whether the adjacent neighbors of the first beam are used. If an adjacent neighbor beam is not used i.e., no user reported this particular neighbor beam as the best beam, the neighbor beam could be included in the set of the beams to be merged.

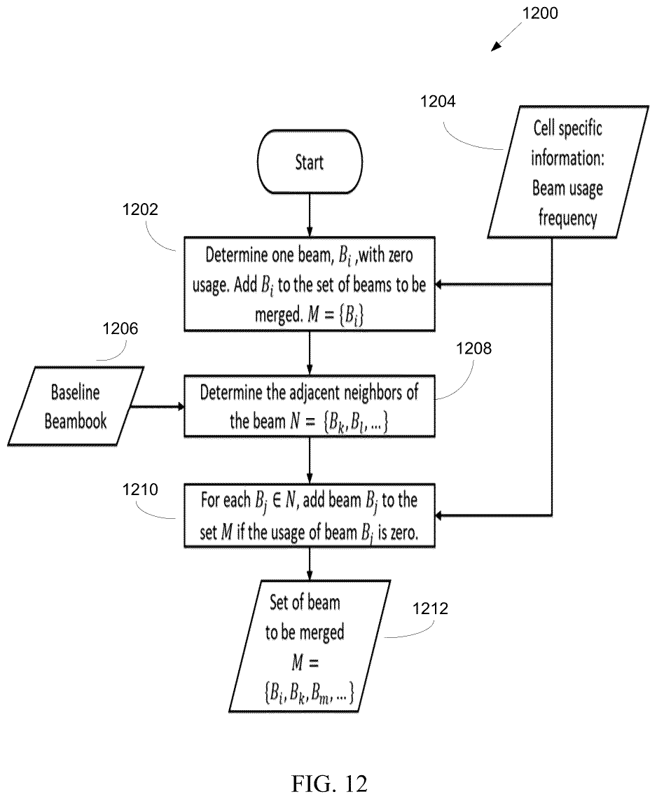

FIG. 12 illustrates another flowchart of method 1200 for beam merging according to various embodiments of the present disclosure. The method 1200 may be performed by a BS (e.g., 101-103 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, in step 1202, one beam is determined with zero usage. In step 1204, cell specific information (e.g., beam usage frequency) is provided to step 1202. In step 1206, a baseline beambook is provided to step 1208. In step 1208, the adjacent neighbors of the beam are determined. In step 1210, for each beam, a beam is added. In step 1212, a set of beams is merged into a group of beams, M.

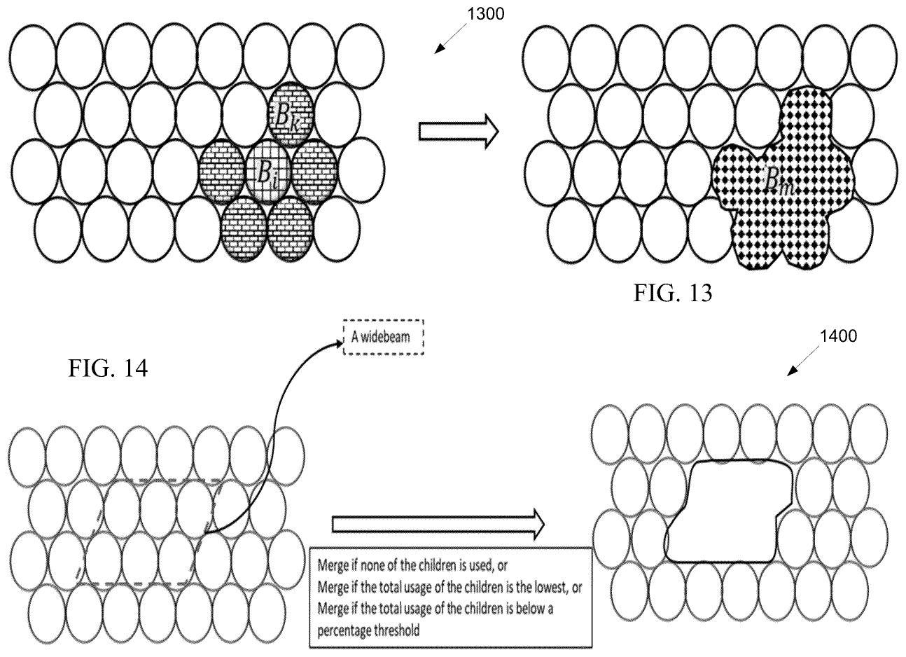

FIG. 13 illustrates another example of beam merging 1300 according to various embodiments of the present disclosure. An embodiment of the beam merging 1300 shown in FIG. 13 is for illustration only.

In one embodiment, the algorithm could determine a beam with zero usage in the collected cell specific information i.e., no user reported this particular beam as the best beam. The determined beam could be included as the first beam in the set of the beams to be merged. Next, the algorithm could determine whether the adjacent neighbors of the first beam are used. If a neighbor beam is not used i.e., no user reported this particular neighbor beam as the best beam, the neighbor beam could be included in the set of the beams to be merged. Next, the algorithm can extend and check the adjacent beams of the first set of determined beams. Checking the adjacent of the last visited beams could be extended until all the beams in the beambook set is checked.

In one embodiment, the set of candidate beams can also be determined based on low usage. The algorithm could determine a beam with low usage in the collected cell specific information i.e., the usage of this beam is lower than a scaling coefficient times the average beam usage. The determined beam could be included as the first beam in the set of the beams to be merged. Next, the algorithm could determine whether the adjacent neighbors of the first beam have low usage. If a neighbor beam has low usage the neighbor beam could be included in the set of the beams to be merged. Next, the algorithm can extend and check the adjacent beams of the first set of determined beams. Checking the adjacent of the last visited beams could be extended until all the beams in the beambook set is checked.

In one example, a hierarchical beambook could be used where a BS utilizes two beambook one with wide beam another one with narrow beams. In one example, wide beams could be used for SSB transmission and initial attachment, and narrow beams could be used for control signaling and data transmission. In one example, the BS could achieve beam refinement, where a BS first obtains information of the best wide beam via initial access, second refines its beam via measurements.

Alternatively, the wide beam could also be updated via measurements. In these examples, the BS could maintain a parent-children relationship between wide beams and narrow beams. In one embodiment, the beam sets to be merged determined via utilizing NB-WB, children-parent relationship. In one embodiment, the narrow beams could be merged into their parent wide beam.

In one example, a wide beam could replace all the children if the usage of beams in its children set is all zero. In one example, a wide beam could replace all children if the total usage of beams in its children set is the smallest among all the wide beam children sets. In another example, a wide beam could replace all children if the total usage of beams in its children set is the smaller than a predetermined percentage of usage.

FIG. 14 illustrates yet another example of beam merging 1400 according to various embodiments of the present disclosure. An embodiment of the beam merging 1400 shown in FIG. 14 is for illustration only.

In one embodiment, the beamforming weights of the merged beam could be computed via an optimization framework. The optimization framework could try to maximize a function that captures a specific desired design intent. In one embodiment, the beamforming weights of the merged beam could be optimized to maximize the average beam gain in the area of merging and a loss function representing the average gain could be considered.

An example of such loss function: L₁(\vec{wₘ})=Σ_{(θ}_{ᵢ}_{,φ}_{ᵢ}_{)∈A}_{_{M}}|α(θᵢ, φᵢ)^{H}Wₘ|, where \vec{wₘ} is the beamforming weights of the merged beam, the α(θᵢ, φᵢ) is the BS array gain towards spatial angle direction (θᵢ, φᵢ), and A_{M} is the all (θᵢ, φᵢ) directions in the area of merging.

In another embodiment, the beamforming weights could be optimized to maximize the lowest beam gain in the area of merging and a loss function representing this could be considered.

An example of such loss function:

$${L}_{2} ( \vec{{w}_{m}} ) = {min}_{( {θ}_{i} , {ϕ}_{i} ) ∈ {A}_{M}} \vert {a ( {θ}_{i} , {ϕ}_{i} )}^{H} {W}_{m} \vert .$$

In another embodiment, the beamforming weights could be optimized to maximize the lowest beam gain in the area of merging while simultaneously maximizing the average beamforming gain in the merge area. Various loss functions facilitating this design intent could be considered. Some examples of such loss functions could be based on many convex (or concave with appropriate sign change) functions and could be based on a distance from a target gain value where target is set variably based on softmin, Huber loss, and/or quantile loss.

Examples could include L₃ (\vec{wₘ})=Σ_{(θ}_{ᵢ}_{,φ}_{ᵢ}_{)∈A}_{_{M}} F(|α(θᵢ, φᵢ)^{H}Wₘ|) where F is a convex function, L₄ (\vec{wₘ})=Σ_{(θ}_{ᵢ}_{,φ}_{ᵢ}_{)∈A}_{_{M}}|T_{gain}−|α(θᵢ, φᵢ)^{H}Wₘ∥ where T_{gain} is a suitable target gain, L₅ (\vec{wₘ})=μ_{g}−λ[μ_{g}−softmin(A_{M}, Wₘ) where μ_{g} is the average gain.

In one embodiment, the optimization framework could be based on an iterative algorithm. One example of an iterative algorithm could be cyclic coordinate descent algorithm.

In one embodiment, the optimization framework could be a neural network based. The beamforming weights could be represented on neural network as one fully connected layer weights. The bias values could be set to zero. In one example, the beamforming weights could be constrained to be unit amplitude, achieving analog beamforming. In some examples, this constraint could be relaxed based on the hardware architecture and achieve digital beamforming. In some examples, a hybrid antenna hardware could be considered by relaxing/imposing constraints on the beamforming weights.

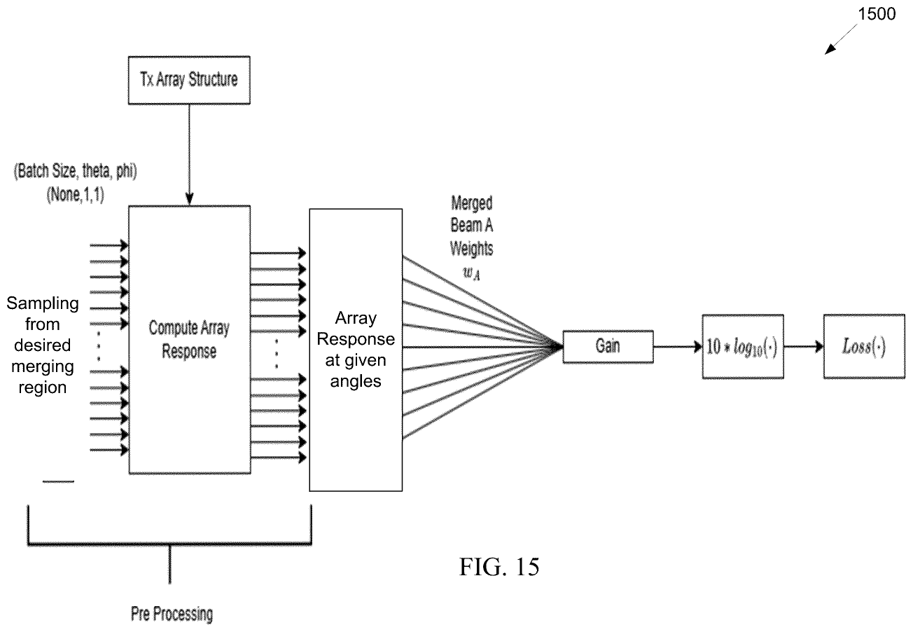

FIG. 15 illustrates an example of beamforming weight optimization 1500 according to various embodiments of the present disclosure. An embodiment of the beamforming weight optimization 1500 shown in FIG. 15 is for illustration only.

In one embodiment, an optimizer could be utilized to optimize the beamforming weights via a neural network structure. One example of an optimizer could be a gradient descent algorithm. Examples of gradient descent algorithm based optimizers could include stochastic gradient descent and other optimizers. In one embodiment, the beamforming weights could be updated using backpropagation.

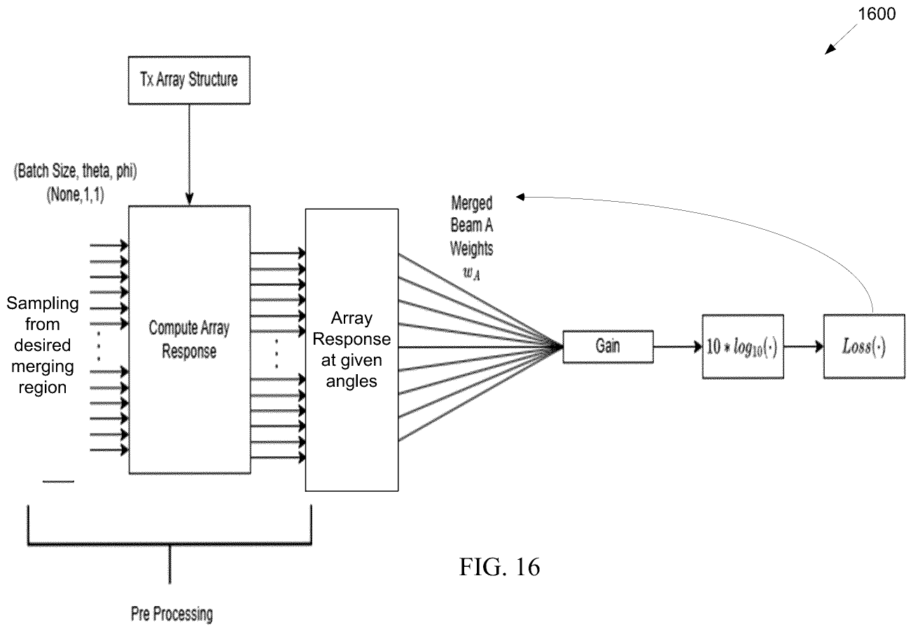

FIG. 16 illustrates an example of beamforming weight optimization 1600 according to various embodiments of the present disclosure. An embodiment of the beamforming weight optimization 1600 shown in FIG. 16 is for illustration only.

In one embodiment, the neural network based algorithm could have access to large amount of angular samples, and corresponding array responses. In one embodiment, the angles corresponding to the regions of beams to be merged could be used as the input of the neural network. In one embodiment, the beam gains in the angular region could be computed first via passing the angular region (or samples from the angular region) as an input, second computing array response corresponding to the angles, third multiplying beam weights to the complex conjugate of the array responses where the beam weights are represented by fully connected layer weights in a neural network.

In one embodiment, the design target could be improving beamforming gain in the vicinity of one or more frequently used beams. The beamforming gain could be improved via splitting the beams in the region to more beams. In one embodiment, the beambook update algorithm could determine the most frequently used beam, Bₘ, using the collected cell specific information. The most used beam Bₘ could be included in the set of beams to be split.

In one embodiment the adjacent neighbors of the most used beam, set N, could be determined. Among these neighbor beams, the most used neighbor beam, Bⱼ could be determined. The most used neighbor beam Bⱼ could be included in the set of beams to be split. The most used beam Bₘ and its most used neighbor beam Bⱼ could indicate that there could be a high user density in the cell area that these two beams serve.

In one example, it could be desirable to improve beamforming gain towards this densely populated or frequently used area. One way to achieve improved beamforming gain could be determining a new beamforming weight that can supplement the service towards the dense user region. In one example, the two beams in the set of beams to be split, could be split into three beams serving the original area. With the addition of new beam, this triplet of beams could serve the area with improved beamforming gain.

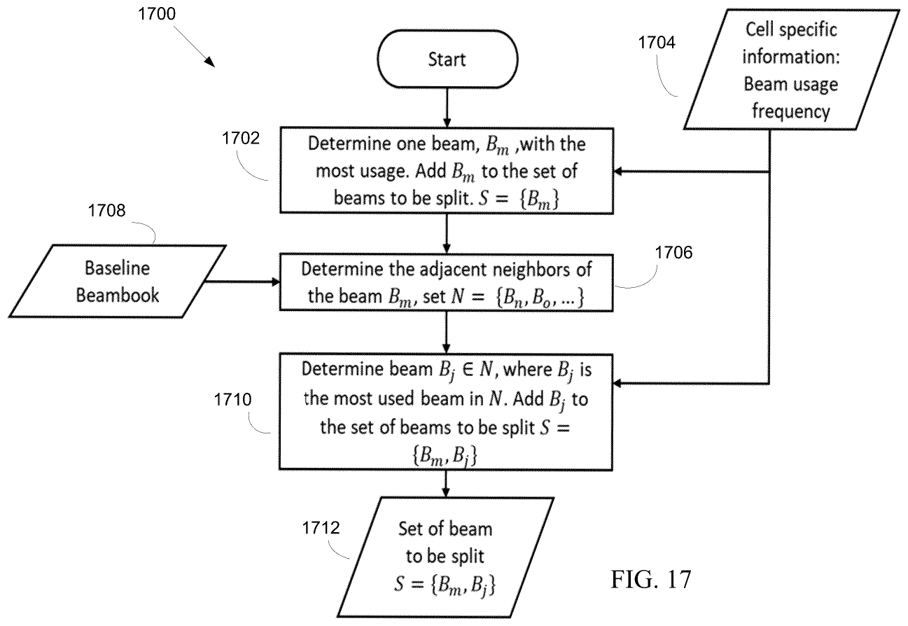

FIG. 17 illustrates another flowchart of method 1700 for beam splitting according to various embodiments of the present disclosure. The method 1700 may be performed by a BS (e.g., 101-103 as illustrated in FIG. 1). An embodiment of the method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, in step 1702, one beam is determined with the most usage and the most usage beam is added to the set of beams to be split. In step 1704, cell specific information (e.g., beam usage frequency) is provided to step 1702. In step 1706, the adjacent neighbors of the beam are determined. In step 1708, a baseline beambook is provided to step 1706. In step 1710, beam is determined. In step 1712, a set of beams to be split is identified.

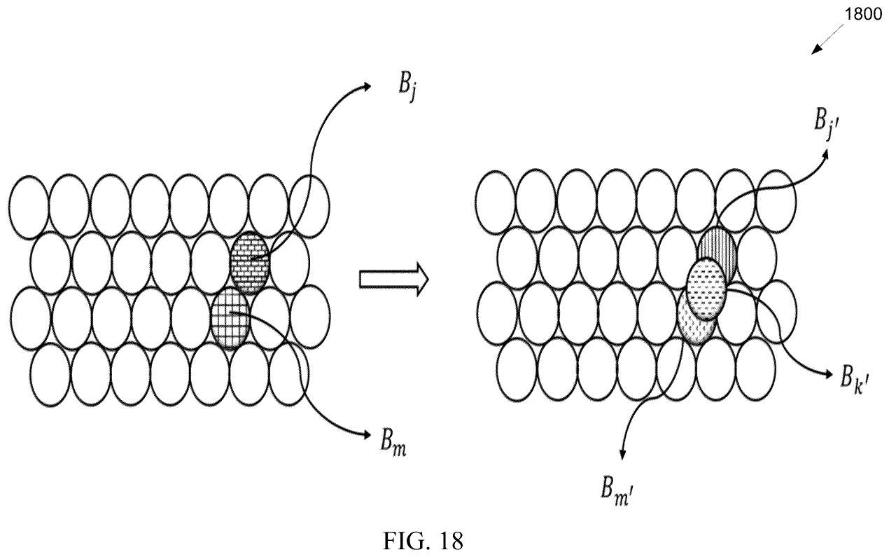

FIG. 18 illustrates yet another example of beam splitting 1800 according to various embodiments of the present disclosure. An embodiment of the beam merging 1800 shown in FIG. 18 is for illustration only.

In one embodiment, the split operation could be achieved via determining the centers of the beams in the split set S, determining the middle point of the two centers, assigning the middle point as the center of the third beam B_{k′}, and determining beamforming weights using the steering angle and the array response at the steering angle of this new center.

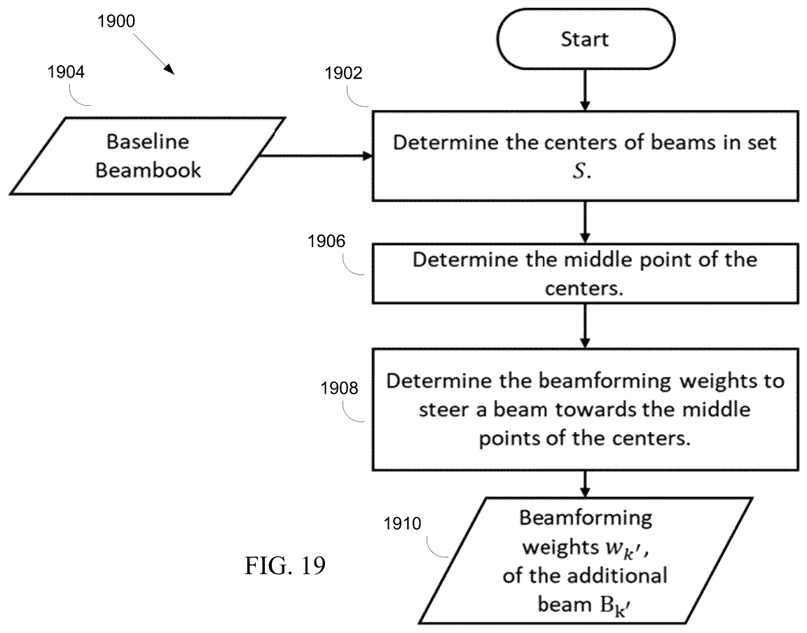

FIG. 19 illustrates another flowchart of method 1900 for identifying beamforming weight according to various embodiments of the present disclosure. The method 1900 may be performed by a BS (e.g., 101-103 as illustrated in FIG. 1). An embodiment of the method 3000 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions.

As illustrated in FIG. 19, in step 1902, the centers of beams in a set are determined. In step 1904, a baseline beambook is provided to step 1902. In step 1906, the middle point of the centers is determined. In step 1908, the beamforming weights are determined to steer a beam towards the middle points of the centers. In step 1910, beamforming weights of the additional beam is identified.

In one embodiment, the beamforming gain achieved after the beam split could be further optimized. The optimization algorithm starts with constructing a set S′={B_{m′}, B_{j′}, B_{k′}} where B_{m′} and B_{j′}, are initialized as the copies of beams Bₘ and Bⱼ and their weights are initialized as the weights of beams Bₘ and Bⱼ. The weights of B_{k′} are initialized as the steering beamforming weights towards the center location of the beams Bₘ and Bⱼ. Next, the beamforming weights of the beams in the set of beams to be split S′ could be further optimized via an optimization framework.

The optimization framework could try to maximize a function that captures a specific design objective or intent. In one embodiment, the beamforming weights of the split beams could be optimized to maximize the average beam gain in the area of splitting and a loss function representing the average gain could be considered.

An example of such loss function:

$${L}_{6} ( W ) = {\sum }_{( {θ}_{i} , {ϕ}_{i} ) ∈ {A}_{s}} {max}_{x ∈ {I}_{{S}^{′}}} \vert {a ( {θ}_{i} , {ϕ}_{i} )}^{H} {w}_{x} \vert ,$$

where W=[\vec{w_{m′}}, \vec{w_{j′}}, \vec{w_{k′}} is a matrix where columns are the beamforming weights of the beams in S′, the α(θᵢ, φᵢ) is the BS array gain towards spatial angle direction (θᵢ, φᵢ), and Aₛ is the all (θᵢ, φᵢ) directions in the area of splitting covered by the original beams in set S, and I_{S′} is the indices of the beams in the set of beams to be split, e.g., I_{S′}={m′, j′, k′} when S′={B_{m′}, B_{j′}, B_{k′}}.

In another embodiment, the beamforming weights could be optimized to maximize the lowest beam gain in the area of split and a loss function representing this could be considered. An example of such loss function:

$${L}_{7} ( W ) = {min}_{( {θ}_{i} , {ϕ}_{i} ) ∈ {A}_{S}} {max}_{x ∈ {I}_{{S}^{′}}} \vert {a ( {θ}_{i} , {ϕ}_{i} )}^{H} {w}_{x} \vert .$$

In another embodiment, the beamforming weights could be optimized to maximize the lowest beam gain in the area of split while simultaneously maximizing the average beamforming gain in the split area. Various loss functions facilitating this design intent could be considered.

Some examples of such loss functions could be based on many convex (or concave with appropriate sign change) functions, could be based on a distance from a target gain value where target is a value set via initial assessment, another loss function based on softmin, another loss function based on Huber loss, another loss function based on quantile loss.

Examples could include

$${L}_{8} ( W ) = {\sum }_{( {θ}_{i} , {ϕ}_{i} ) ∈ {A}_{S}} F ( {max}_{x ∈ {I}_{{S}^{′}}} \vert {a ( {θ}_{i} , {ϕ}_{i} )}^{H} {w}_{x} \vert )$$

where F is a convex function,

$${L}_{9} ( W ) = {\sum }_{( {θ}_{i} , {ϕ}_{i} ) ∈ {A}_{S}} \vert {T}_{gain} - {max}_{x ∈ {I}_{{S}^{′}}} \vert {a ( {θ}_{i} , {ϕ}_{i} )}^{H} {w}_{x} \vert \vert$$

where T_{gain} is a suitable target gain, L₁₀ (W)=μ_{g}−λ[μ_{g}-softmin (A_{S}, W)] where μ_{g} is the average gain.

In one embodiment, the optimization framework could be based on an iterative algorithm. One example of an iterative algorithm could be cyclic coordinate descent algorithm.

In one embodiment, the optimization framework could be neural network based. The beamforming weights could be represented on neural network as one fully connected layer weights. The bias values could be set to zero. In one example, the beamforming weights could be constrained to be unit amplitude, achieving analog beamforming. In some examples, this constraint could be relaxed based on the hardware architecture and achieve digital beamforming. In some examples, a hybrid antenna hardware could be considered by relaxing/imposing constraints on the beamforming weights.

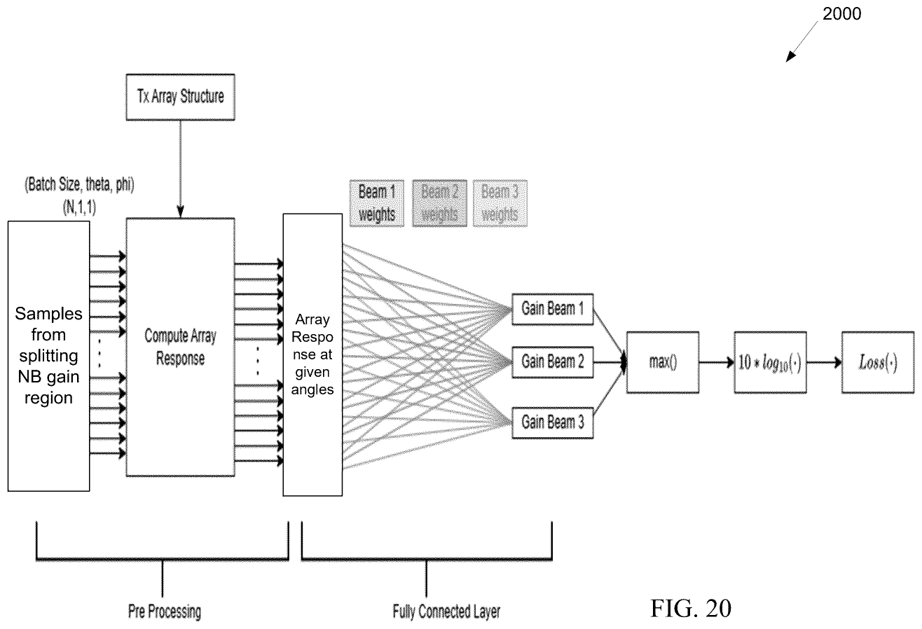

FIG. 20 illustrates another example of beamforming weight optimization 2000 according to various embodiments of the present disclosure. An embodiment of the beamforming weight optimization 2000 shown in FIG. 20 is for illustration only.

In one embodiment, an optimizer could be utilized to optimize the beamforming weights via a neural network structure. One example of the optimizer could be a gradient descent algorithm. Examples of gradient descent algorithm-based optimizers could include stochastic gradient descent and other optimizers. In one embodiment the beamforming weights could be updated using backpropagation.

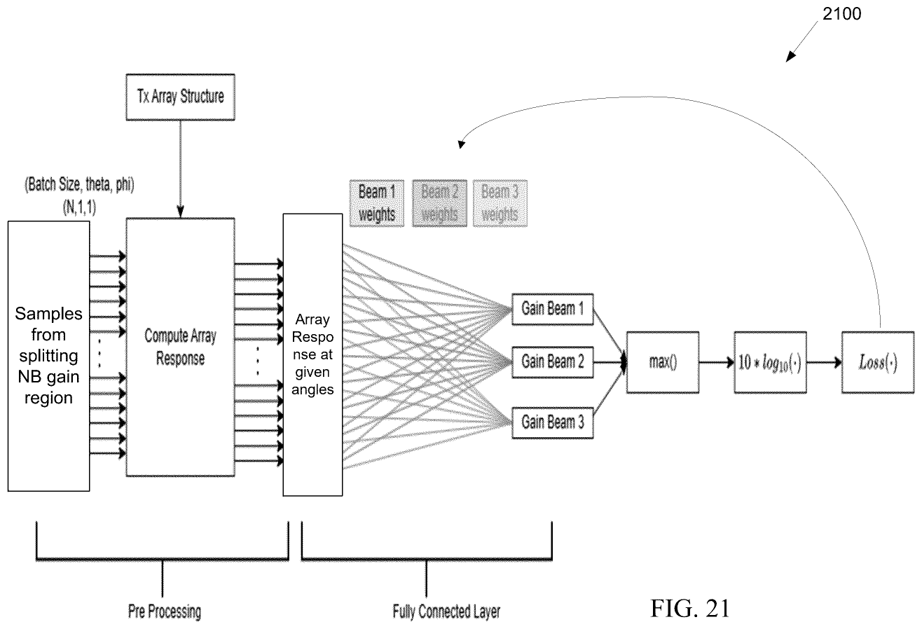

FIG. 21 illustrates another example of beamforming weight optimization 2100 according to various embodiments of the present disclosure. An embodiment of the beamforming weight optimization 2100 shown in FIG. 21 is for illustration only.

In one embodiment, the neural network based algorithm could have access to large amount of angular samples, and corresponding array responses. In one embodiment, the angles corresponding to the regions of beams to be split could be used as the input of the neural network.

In one embodiment, the gains in the angular region could be computed first via passing the angular region (or samples from the angular region) as an input, second computing array response corresponding to the angles, third multiplying beam weights to the array responses where the beam weights are represented with neural network fully connected layer weights, fourth determining maximum among the output of the fully connected layer i.e., picking the beam achieving highest gain.

More generally, the split algorithm can be applied to any number of beams. In one example, algorithms could split K beams to L beams. The algorithm first determines the initial set of beams to be split, S={B₁, B₂, . . . , B_{K}}. Second, the algorithm determines the angular sampling input area A_{S}, for the beams in S. Third the algorithm determines the number of additional beams required R, where R=L-K. Fourth, the algorithm samples R steering angles from A_{S}, and determines the suitable steering vectors Wᵢ, which are beamforming towards the sampled angles. Fifth, the algorithm constructs a set with the beams which are beamforming towards the sampled angles, Q={V₁, V₂, . . . , V_{R}}. Sixth, the algorithm constructs the initial set of split beams S′={B_{1′}, B_{2′}, B_{3′}, . . . , B_{K′}} U {V_{1′}, V_{2′}, . . . , V_{R′}}.

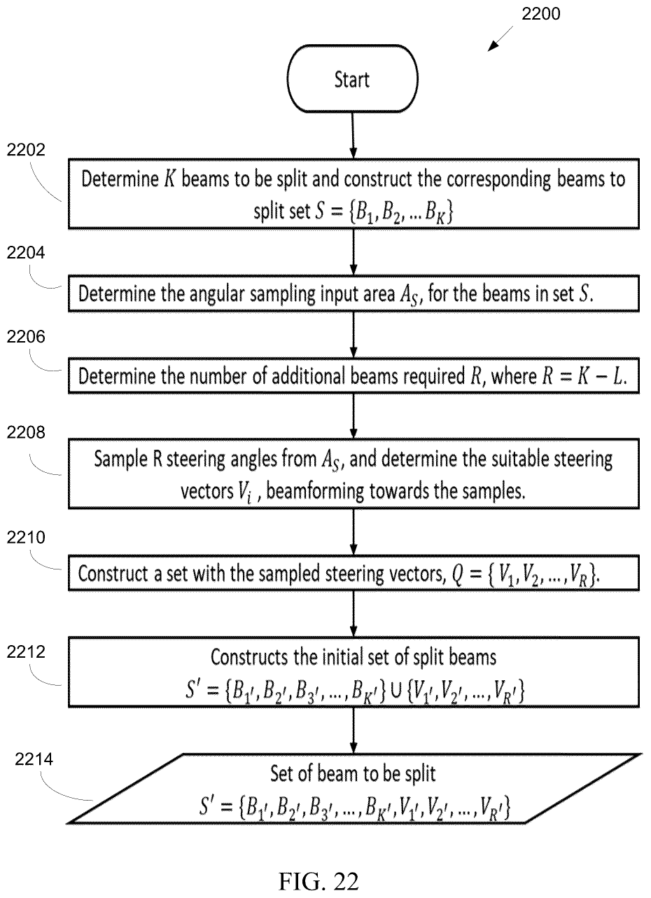

FIG. 22 illustrates a flowchart of method 2200 for splitting a set of beams according to various embodiments of the present disclosure. The method 2200 may be performed by a BS (e.g., 101-103 as illustrated in FIG. 1). An embodiment of the method 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

As illustrated in FIG. 22, in step 2202, K beams to be split are determined and the corresponding beams to split are constructed. In step 2204, the angular sampling input area for the beams in a set is determined. In step 2206, the number of additional beams required is determined. In step 2208, R steering angles are sampled from As and the suitable steering vectors are determined. In step 2210, a set with the sample steering vectors is constructed. In step 2212, the initial set of split beams is constructed. In step 2212, a set of beams to be split is identified.

In one embodiment, the initial set of K beams to be split could be based on their usage statistics. In the context of beams, the beam pattern could be used to construct a graph representation of beams, where there is said to be an edge in the graph if two beams are adjacent neighbors in the beam pattern. In one embodiment, the algorithm could search for K nodes that are connected-components each other, where the total usage is maximized. A connected component is defined as a subset of nodes in a graph where each node in connected component set is connected to every other node in the set.

In one example, a hierarchical beambook could be used where a BS utilizes two beambook one with wide beam another one with narrow beams. In one example, wide beams could be used for SSB transmission and initial attachment, and narrow beams could be used for control signaling and data transmission. In one example, the BS could achieve beam refinement, where a BS first obtains information of the best wide beam via initial access, second refines its beam via measurements.

Alternatively, the wide beam could also be updated via measurements. In these examples, the BS could maintain a parent-children relationship between wide beams and narrow beams. In one embodiment, the initial set of beams to be split could be determined via utilizing NB-WB, children-parent relationship. In one embodiment, first, the algorithm could determine a total number of usages of the children of a wide beam. Second, the algorithm could determine the WB for which its children have the most total usage. Third the algorithm could use the children set as beams to be split. In one example, if the children set has K beams, and the target number of beams after split is L, the algorithm could construct initial set of beams to be split as the K children beams and R additional steering vectors pointing to angles sampled from the A_{S} area, where R=L−K.

In one embodiment, there could be a limit imposed on the maximum number of children beam for each wide beam. In such scenarios, the split algorithm could determine a final number of beams after split L, that is not conflicting within the maximum number of children beam limit.

In one embodiment, a merging operation could be used to merge beams, followed by a split operation. In one embodiment, the design could have one objective to keep the beambook size as a constant. First, a merge operation could merge M beams to a single beam. This may create M−1 vacant positions in the beambook size budget. Next, the algorithm could determine K beams to be split and split these beams to L beams, where L=K+M−1 to maintain the fixed beambook size.

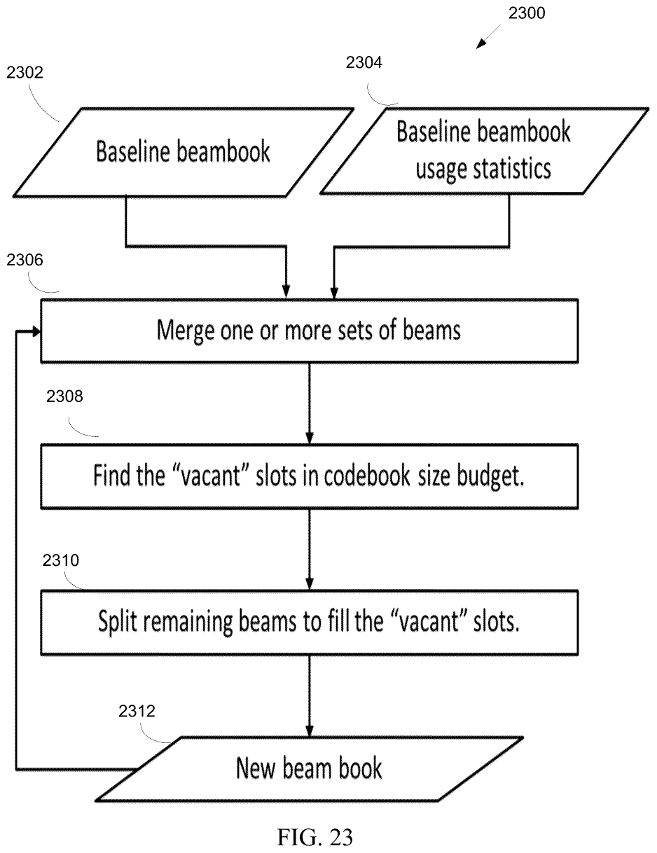

FIG. 23 illustrates a flowchart of method 2300 for splitting a set of beams and identifying a new beam according to various embodiments of the present disclosure. The method 2300 may be performed by a BS (e.g., 101-103 as illustrated in FIG. 1). An embodiment of the method 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

As illustrated in FIG. 23, in step 2302, a baseline beambook is identified and provided to step 2306. In step 2304, baseline beambook usage statistics are identified and provided to step 2306. In step 2306, one or more sets of beams are merged. In step 2308, the “vacant” slots in codebook size budget are found. In step 2310, remaining beams is split to fill the “vacant” slots. In step 2312, a new beam book is identified.

In one embodiment, a first merging step could be performed for every WB where a total usage of children is zero, where the children are merged into their parent wide beam. A second merging step could be performed for siblings where the usage is zero but at least one sibling has nonzero usage so that merging into parent beam did not happen in first step. In the second merge step, all the siblings with zero usage could be merged into one beam. Alternative methods to construct set of beams to be merged could also be used. Third, the algorithm determines total number of beams merged and determines number of available vacant spots. Fourth, the algorithm splits one or more sets of beams. Fifth, the algorithm determines the final beambook.

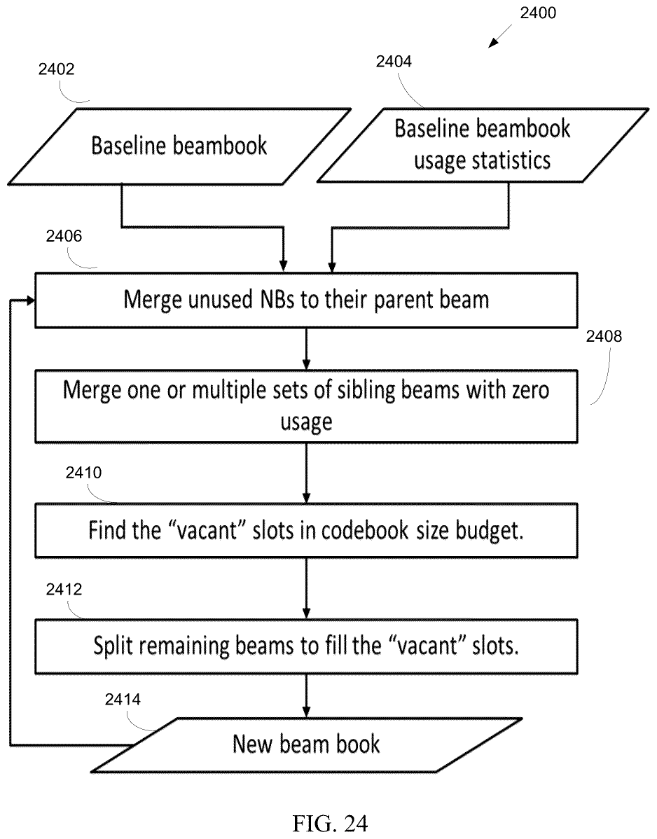

FIG. 24 illustrates another flowchart of method 2400 for merging and splitting a set of beams and identifying a new beam according to various embodiments of the present disclosure. The method 2400 may be performed by a BS (e.g., 101-103 as illustrated in FIG. 1). An embodiment of the method 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

As illustrated in FIG. 24, in step 2402, a baseline beambook is identified and provided to step 2406. In step 2402, baseline beambook usage statistics are identified and provided to step 2406. In step 2406, unused NBs are merged to their parent beam. In step 2408, one or more multiple sets of sibling beams are merged with zero usage. In step 2410, the “vacant” slots are found in codebook size budget. In step 2412, remaining beams are split to fill the “vacant” slots. In step 2414, a new beam book is identified.

In one embodiment, the cell specific beambook could be designed based on channel state information of the users in a cell. A collection of channel state information could be obtained via a downlink or uplink channel measurement.

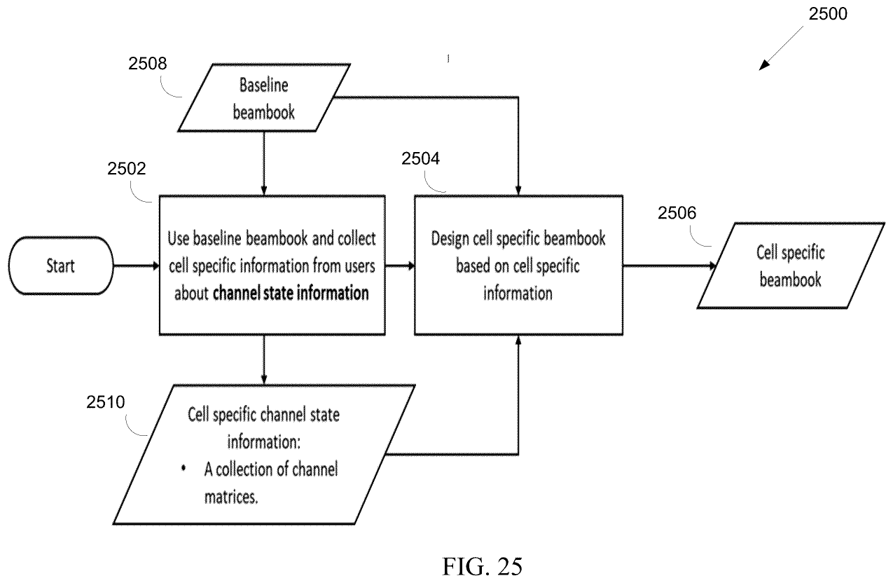

FIG. 25 illustrates a flowchart of method 2500 for cell specific design according to various embodiments of the present disclosure. The method 2500 may be performed by a BS (e.g., 101-103 as illustrated in FIG. 1). An embodiment of the method 2500 shown in FIG. 25 is for illustration only. One or more of the components illustrated in FIG. 25 can be implemented in specialized circuitry configured to perform the noted functions or one or more of the components can be implemented by one or more processors executing instructions to perform the noted functions.

As illustrated in FIG. 25, in step 2502, baseline beambook is used and cell specific information is collected from users about channel state information. In step 2504, cell specific beambook is designed based on cell specific information. In step 2506, a cell specific beambook is identified. In step 2508, a baseline beambook is identified and provided to step 2502. In step 2510, cell specific channel state information is identified (e.g., a collection of channel matrices).

In one embodiment, the merger and split algorithms could be modified to optimize the loss using the channel state information. In one example, consider a channel state information Cu of a user u. The cell specific channel state information could be used to merge and split beams.

In one embodiment, the merge algorithm could be modified as follows. First, the algorithm determines M, a set of beams to be merged. Second, the algorithm determines the user indices set U^{M}={u₁, u₂, . . . u_{|U|}}, where U includes all the users that reported any beam in set M.

In one embodiment, the beamforming weights of the merged beam could be computed via an optimization framework. The optimization framework could try to maximize a function that captures a specific desired design intent. In one embodiment, the beamforming weights of the merged beam could be optimized to maximize the average beam gain for all users in set U^{m}, i.e, u ∈ U_{M}, and a loss function representing the average gain could be considered.

An example of such loss function: L₁₁(\vec{wₘ})=Σ_{u ∈U}M|CᵤWₘ|, where wₘ is the beamforming weights of the merged beam, the Cu is the channel state information of the user u. It is apparent that the other loss functions introduced in merging using angular region could be modified to use channel state information.

In one embodiment, the optimization framework could be a neural network based. The beamforming weights could be represented on neural network as one fully connected layer weights. The bias values could be set to zero. The merge algorithm could be modified as follows. First, the algorithm determines M, a set of beams to be merged. Second, the algorithm determines the user indices set U^{M}={u₁, u₂, . . . u_{|U|}}, where U includes all the users that reported any beam in set M. Third, the algorithm samples a batch of user indices from set U^{M}. Fourth, the algorithm determines the corresponding channel state information for the sampled batch of users. Fifth, the algorithm could obtain gain values for batch of users via multiplying beam weights to the array responses where the beam weights are represented with neural network fully connected layer weights. Sixth, optimize the beamforming weights via using a loss function, and using an optimizer, and using backpropagation as commonly used in deep learning framework.

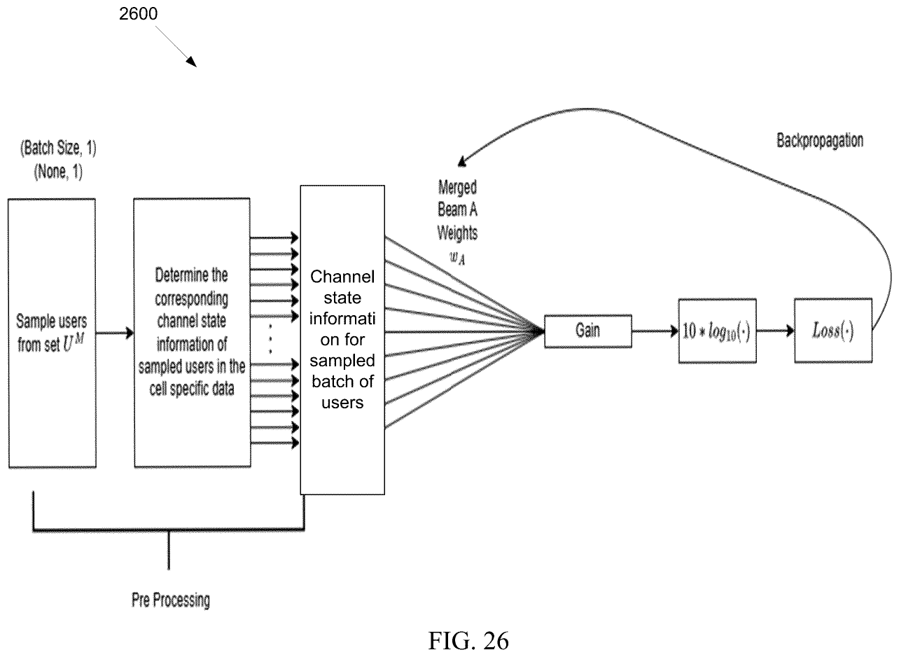

FIG. 26 illustrates yet another example of beamforming weight optimization 2600 according to various embodiments of the present disclosure. An embodiment of the beamforming weight optimization 2600 shown in FIG. 26 is for illustration only.

In other embodiments, the split algorithm could be modified similar to the merge algorithm modifications to use the channel state information. The modifications for split algorithm are apparent.

In one embodiment, the baseline beambook could be a cell common beambook.

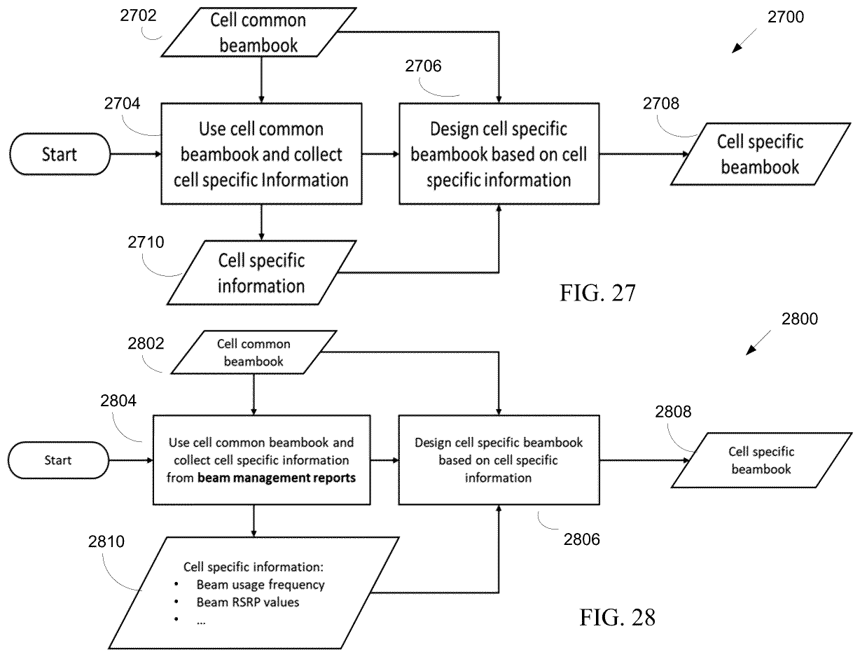

FIG. 27 illustrates another flowchart of method 2700 for cell specific design according to various embodiments of the present disclosure. The method 2700 may be performed by a BS (e.g., 101-103 as illustrated in FIG. 1). An embodiment of the method 2700 shown in FIG. 27 is for illustration only. One or more of the components illustrated in FIG. 27 can be implemented in specialized circuitry configured to perform the noted functions or one or more of the components can be implemented by one or more processors executing instructions to perform the noted functions.

As illustrated in FIG. 27, in step 2702, a cell common beambook is identified and provided to step 2704. In step 2704, cell common beambook is used and cell specific information is collected. In step 2706, a cell specific beambook is designed based on cell specific information. In step 2708, a cell specific beambook is identified. In step 2710, cell specific information is identified.

In one embodiment, the cell specific beambook could be designed based on usage frequencies of beams and/or the RSRP reports of beams when the cell common beambook is in use.

FIG. 28 illustrates yet another flowchart of method 2800 for cell specific design according to various embodiments of the present disclosure. The method 2800 may be performed by a BS (e.g., 101-103 as illustrated in FIG. 1). An embodiment of the method 2800 shown in FIG. 28 is for illustration only. One or more of the components illustrated in FIG. 28 can be implemented in specialized circuitry configured to perform the noted functions or one or more of the components can be implemented by one or more processors executing instructions to perform the noted functions.

As illustrated in FIG. 28, in step 2802, a cell common beambook is identified and provided to step 2804. In step 2804, a cell common beambook is used and cell specific information is collected from beam management report. In step 2806, a cell specific beambook is designed based on cell specific information. In step 2808, a cell specific beambook is identified. In step 2810, cell specific information is identified (e.g., beam usage frequency, beam RSRP values etc.).

In one embodiment, the cell specific beambook could be designed based on usage frequencies of beams and/or the RSRP reports of beams when the cell common beambook is in use.

In one embodiment, the baseline beambook could be a previously designed cell specific beambook. In one embodiment, the cell specific beambook could be designed based on usage frequencies of beams and/or the RSRP reports of beams when the previously designed cell specific beambook is in use.

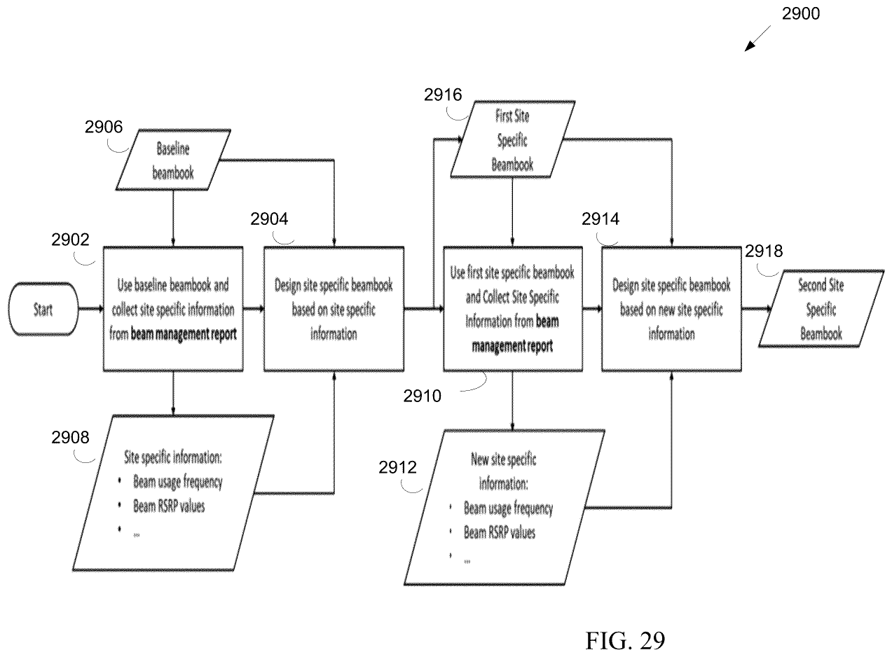

FIG. 29 illustrates yet another flowchart of method 2900 for cell specific design according to various embodiments of the present disclosure. The method 2900 may be performed by a BS (e.g., 101-103 as illustrated in FIG. 1). An embodiment of the method 2900 shown in FIG. 29 is for illustration only. One or more of the components illustrated in FIG. 29 can be implemented in specialized circuitry configured to perform the noted functions or one or more of the components can be implemented by one or more processors executing instructions to perform the noted functions.

As illustrated in FIG. 29, in step 2902, a baseline beambook is used and site specific information is collected from a beam management report. In step 2904, a site specific beambook is designed based on site specific information. In step 2906, a baseline beambook is identified and provided to step 2902. In step 2908, site specific information is identified (e.g., beam usage frequency, beam RSRP values etc.). In step 2910, a first site specific beambook is used and site specific information is collected from a beam management report. In step 2912, new site specific information is identified (e.g., beam usage frequency, beam RSRP values etc.). In step 2914, a site specific beambook is designed based on new site specific information. In step 2916, a first site specific beambook is provided to step 2910. In step 2918, a second site specific beambook is identified.

In one embodiment, the design procedure could be repeated at least once. The design procedure could be triggered based on a fixed duration, i.e., once every hour, once a day, once a week, and so on.

In one embodiment, the update of cell-specific design could be triggered based on the volume of the collected cell specific information. In one embodiment, the design procedure could be triggered via a performance indicator and a monitor process.

It is contemplated that many variations associated with the disclosed technology are possible.

In the present disclosure, the provided methods and algorithms are to update, redesign beambooks based on cell specific data in 5G mmWave BS. Future 6G BS product(s) could also benefit from the methods in the present disclosure. The described algorithms can be used to design a new beambook that has the potential to improve the spectral efficiency, therefore improving both the downlink and uplink throughput of the network.

The current mmWave products support non real-time ran intelligent controller (Non-RT RIC). The non-RT RIC is a key enable for this type of cell specific design. A framework on how to collect data, maintain the new beambook and update, and monitor performance is also provided in the present disclosure. It is likely to be used in software packages of mmWave base stations. The present disclosure could also be applicable in other frequency bands including FR1 and future FR3 bands.

A beam management and beambook design are a key component in FR2 frequencies and are still very important in FR1 and FR3 bands. With the current shift in technology, many products now utilize AI/ML tools. One application of AI/ML based design could be optimizing beambook. Many aspects covered in the present disclosure relate to beambook design utilizing AI/ML and cell specific information. The beam codebook pattern can be measured in a measurement chamber.

For a BS implementing cell specific beambook updates, the procedure below could be followed: (i) an initial beam pattern measurement for a BS is performed, (ii) via a beam reporting procedure, report certain beam indices with high frequency and certain beam indices with low frequency, (iii) wait until the BS beambook is updated, (iv) if the BS beambook is updated, perform a beam pattern measurement, (v), the initial measurement and final measurement patterns are compared, and (vi) determined if most frequently reported beam regions have higher beam density and least frequently reported beam regions have lower beam density in their respective vicinities. If the density is changed according to reports, there was a beambook update based on statistics collected from this cell.

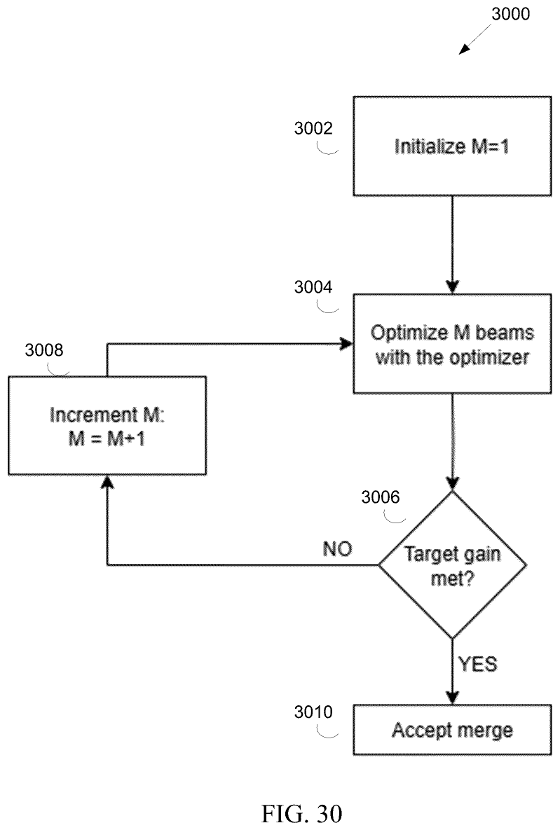

FIG. 30 illustrates a flowchart of method 3000 for a merging operation according to various embodiments of the present disclosure. The method 3000 may be performed by a network entity (e.g., base station, 101-103 as illustrated in FIG. 1). An embodiment of the method 3000 shown in FIG. 30 is for illustration only. One or more of the components illustrated in FIG. 30 can be implemented in specialized circuitry configured to perform the noted functions or one or more of the components can be implemented by one or more processors executing instructions to perform the noted functions.

As illustrated in FIG. 30, a merging operation could be done to merge K beams into M new beams where M<K. In one example, M=1 could be the starting point (e.g., step 3002). If the composite beam gain of M new beams meets the target threshold (e.g., 3006), this merging operation is accepted and the rest of the design is carried out. If the composite beam gain of M new beams is less than the target gain, M is incremented (e.g., step 3008) by one i.e., M<M+1, and the merging operation is carried out once more (e.g., step 3004), until the target threshold is met or M=K. Finally, the merging operation is accepted (e.g., step 3010).

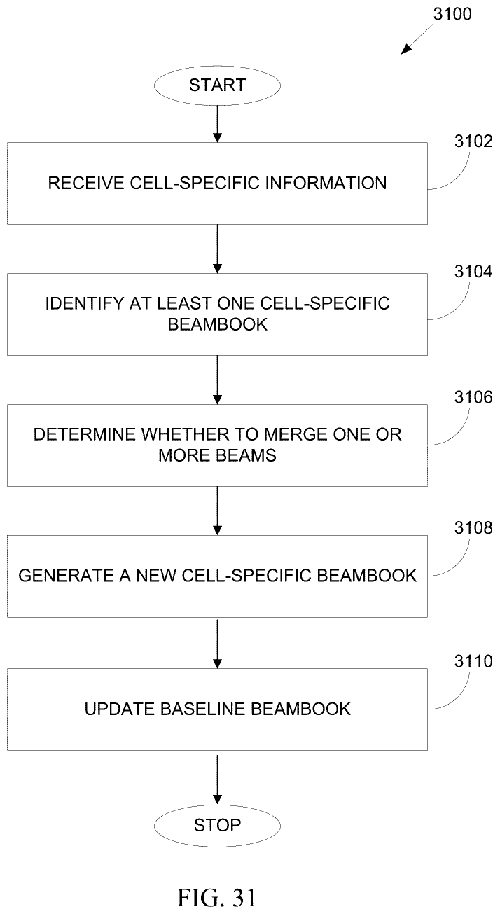

FIG. 31 illustrates a flowchart of method 3100 for a cell specific beambook design according to various embodiments of the present disclosure. The method 3100 may be performed by a BS (e.g., 101-103 as illustrated in FIG. 1). An embodiment of the method 3100 shown in FIG. 31 is for illustration only. One or more of the components illustrated in FIG. 31 can be implemented in specialized circuitry configured to perform the noted functions or one or more of the components can be implemented by one or more processors executing instructions to perform the noted functions.

As illustrated in FIG. 31, the method 3100 begins at step 3102. In step 3102, a BS receives, from a UE, cell-specific information.

Subsequently, the BS in step 3104 identifies, based on the cell-specific information, at least one cell-specific beambook, wherein the cell-specific information includes beam usage statistics.

Subsequently, the BS in step 3106 determines, based on the cell-specific information and a baseline beambook, whether to merge one or more beams in accordance with a first threshold.

Next, in step 3108, the BS generates a new cell-specific beambook based on a determination that the one or more beams is merged.

Finally, the BS in step 3110 updates the baseline beambook based on the new cell-specific beambook.

In one embodiment, the BS determines, based on the cell-specific information and the baseline beambook, whether to split the one or more beams in accordance with a second threshold. In such embodiments, the second threshold is associated with a number of usages of the one or more beams including neighbor beams.

In such embodiments, the cell-specific information includes: (i) a beam management report comprising at least one of an index of a best beam or an RSRP of the best beam, the beam management report being received within a pre-defined time period, (ii) CSI measured, at the UE, based on downlink pilot signals including a CSI-RS, the CSI being identified, at the BS, based on a feedback loop, or (iii) CSI measured, at the BS, based on uplink pilot signals including an SRS, the CSI identified, at the BS, based on measurements.

In one embodiment, the BS merges one or more beams that are closely located each other to generate at least one beam covering a union of an area. In such embodiment, the first threshold is associated with a number of usages of the one or more beams including neighbor beams.

In one embodiment, the BS identifies, based on a hierarchical beambook, wide beams and narrow beams to generate the cell-specific beambook. In such embodiment, the narrow beams are merged into a wide beam that is wider than the narrow beams based on the beam usage statistics of the narrow beams, the wide beam being a parent beam of the narrow beams.

In one embodiment, the BS identifies a beamforming weight based on the one or more beams that are merged to maximize an average beam gain in a merging area of the one or more beams or maximize a beam gain in the merging area of the one or more beams. In such embodiment, the beamforming weight is identified as a unit amplitude for an analog beamforming operation, a flexible amplitude for a digital beamforming operation, or a mix of the unit amplitude and the flexible amplitude for a hybrid beamforming operation.

In one embodiment, the BS identifies, based on the cell-specific information, a beam that is first frequently used than other beams in the one or more beams, identifies one or more adjacent beams of the beam, identifies an adjacent beam that is frequently used than other beams in the one or more adjacent beams, generates a new beam between the adjacent beam from the one or more beams and the beam that is first frequently used than other beams, and identifies a new beamforming weight for the new beam.

In one embodiment, the BS identifies at least two centers of the one or more beams in a set of split beams; identifies a middle point of the at least two centers as a new center of the one or more beams; identifies a beamforming weight of the adjacent beam using a steering angle and an array response at the new center of the one or more beams; identifies a loss function indicating an average beam gain; and optimizes beamforming weights of entire beams to minimize the loss function.

In such embodiments, a size of the cell-specific beambook is predefined and constantly maintained while merging or splitting the one or more beams to identify a beamforming weight for generating the cell-specific beambook.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the claims appended. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE), cell-specific information; and
a processor operably coupled to the transceiver, the processor configured to:
identify, based on the cell-specific information, at least one cell-specific beambook, wherein the cell-specific information includes beam usage statistics,
determine, based on the cell-specific information and a baseline beambook, whether to merge one or more beams in accordance with a first threshold,
generate a new cell-specific beambook based on a determination that the one or more beams are merged, and
update the baseline beambook based on the new cell-specific beambook.

2. The BS of claim 1, wherein:
the processor is further configured to determine, based on the cell-specific information and the baseline beambook, whether to split the one or more beams in accordance with a second threshold; and
the second threshold is associated with a number of usages of the one or more beams including neighbor beams.

3. The BS of claim 1, wherein the cell-specific information includes:
a beam management report comprising at least one of an index of a best beam or a reference signal received power (RSRP) of the best beam, the beam management report being received within a pre-defined time period;
channel state information (CSI) measured, at the UE, based on downlink pilot signals including a channel state information reference signal (CSI-RS), the CSI being identified, at the BS, based on a feedback loop; or
CSI measured, at the BS, based on uplink pilot signals including a sounding reference signal (SRS), the CSI identified, at the BS, based on measurements.

4. The BS of claim 1, wherein:
the processor is further configured to merge one or more beams that are closely located each other to generate at least one beam covering a union of an area; and
the first threshold is associated with a number of usages of the one or more beams including neighbor beams.

5. The BS of claim 1, wherein:
the processor is further configured to identify, based on a hierarchical beambook, wide beams and narrow beams to generate the cell-specific beambook; and
the narrow beams are merged into a wide beam that is wider than the narrow beams based on the beam usage statistics of the narrow beams, the wide beam being a parent beam of the narrow beams.

6. The BS of claim 5, wherein:
the processor is further configured to identify a beamforming weight based on the one or more beams that are merged to maximize an average beam gain in a merging area of the one or more beams or maximize a beam gain in the merging area of the one or more beams; and
the beamforming weight is identified as a unit amplitude for an analog beamforming operation, a flexible amplitude for a digital beamforming operation, or a mix of the unit amplitude and the flexible amplitude for a hybrid beamforming operation.

7. The BS of claim 1, wherein the processor is further configured to:
identify, based on the cell-specific information, a beam that is first frequently used than other beams in the one or more beams;
identify one or more adjacent beams of the beam;
identify an adjacent beam that is frequently used than other beams in the one or more adjacent beams;
generate a new beam between the adjacent beam from the one or more beams and the beam that is first frequently used than other beams; and
identify a new beamforming weight for the new beam.

8. The BS of claim 7, wherein the processor is further configured to:
identify at least two centers of the one or more beams in a set of split beams;
identify a middle point of the at least two centers as a new center of the one or more beams;
identify a beamforming weight of the adjacent beam using a steering angle and an array response at the new center of the one or more beams;
identify a loss function indicating an average beam gain; and
optimize beamforming weights of entire beams to minimize the loss function.

9. The BS of claim 1, wherein a size of the cell-specific beambook is predefined and constantly maintained while merging or splitting the one or more beams to identify a beamforming weight for generating the cell-specific beambook.

10. A method of a base station (BS) in a wireless communication system, the method comprising:
receiving, from a user equipment (UE), cell-specific information;
identifying, based on the cell-specific information, at least one cell-specific beambook, wherein the cell-specific information includes beam usage statistics;
determining, based on the cell-specific information and a baseline beambook, whether to merge one or more beams in accordance with a first threshold;
generating a new cell-specific beambook based on a determination that the one or more beams is merged; and
updating the baseline beambook based on the new cell-specific beambook.

11. The method of claim 10, further comprising determining, based on the cell-specific information and the baseline beambook, whether to split the one or more beams in accordance with a second threshold,
wherein the second threshold is associated with a number of usages of the one or more beams including neighbor beams.

12. The method of claim 10, wherein the cell-specific information includes:
a beam management report comprising at least one of an index of a best beam or a reference signal received power (RSRP) of the best beam, the beam management report being received within a pre-defined time period;
channel state information (CSI) measured, at the UE, based on downlink pilot signals including a channel state information reference signal (CSI-RS), the CSI being identified, at the BS, based on a feedback loop; or
CSI measured, at the BS, based on uplink pilot signals including a sounding reference signal (SRS), the CSI identified, at the BS, based on measurements.

13. The method of claim 10, further comprising merging one or more beams that are closely located each other to generate at least one beam covering a union of an area,
wherein the first threshold is associated with a number of usages of the one or more beams including neighbor beams.

14. The method of claim 10, further comprising identifying, based on a hierarchical beambook, wide beams and narrow beams to generate the cell-specific beambook,
wherein the narrow beams are merged into a wide beam that is wider than the narrow beams based on the beam usage statistics of the narrow beams, the wide beam being a parent beam of the narrow beams.

15. The method of claim 14, further comprising identifying a beamforming weight based on the one or more beams that are merged to maximize an average beam gain in a merging area of the one or more beams or maximize a beam gain in the merging area of the one or more beams,
wherein the beamforming weight is identified as a unit amplitude for an analog beamforming operation, a flexible amplitude for a digital beamforming operation, or a mix of the unit amplitude and the flexible amplitude for a hybrid beamforming operation.

16. The method of claim 10, further comprising:
identifying, based on the cell-specific information, a beam that is first frequently used than other beams in the one or more beams;
identifying one or more adjacent beams of the beam;
identifying an adjacent beam that is frequently used than other beams in the one or more adjacent beams;
generating a new beam between the adjacent beam from the one or more beams and the beam that is first frequently used than other beams; and
identifying a new beamforming weight for the new beam.

17. The method of claim 16, further comprising:
identifying at least two centers of the one or more beams in a set of split beams;
identifying a middle point of the at least two centers as a new center of the one or more beams;
identifying a beamforming weight of the adjacent beam using a steering angle and an array response at the new center of the one or more beams;
identifying a loss function indicating an average beam gain; and
optimizing beamforming weights of entire beams to minimize the loss function.

18. The method of claim 10, wherein a size of the cell-specific beambook is predefined and constantly maintained while merging or splitting the one or more beams to identify a beamforming weight for generating the cell-specific beambook.

19. A user equipment (UE) in a wireless communication system, the UE comprising:
a processor configured to generate cell-specific information including includes beam usage statistics; and
a transceiver operably coupled to the processor, the transceiver configured to transmit, to a base station (BS), the cell-specific information, wherein:
based on the cell-specific information, at least one cell-specific beambook is identified, based on the cell-specific information and a baseline beambook, whether to merge one or more beams is determined in accordance with a first threshold,
a new cell-specific beambook is generated based on a determination that the one or more beams are merged, and
the baseline beambook is updated based on the new cell-specific beambook.

20. The UE of claim 19, wherein:
a second threshold is identified to determine whether to split the one or more beams in accordance with the second threshold;
the second threshold is associated with a number of usages of the one or more beams including neighbor beams; and
the cell-specific information further includes:
a beam management report comprising at least one of an index of a best beam or a reference signal received power (RSRP) of the best beam, the beam management report being received within a pre-defined time period,
channel state information (CSI) measured, at the UE, based on downlink pilot signals including a channel state information reference signal (CSI-RS), the CSI being identified, at the BS, based on a feedback loop, or
CSI measured, at the BS, based on uplink pilot signals including a sounding reference signal (SRS), the CSI identified, at the BS, based on measurements.
